(19) United States
(12) Patent Application Publication
(10) Pub. No.: US 2009/0158182 A1
(43) Pub. Date: Jun. 18, 2009

(54) Greeting Card System and Method

(75) Inventors: Kevin McCurdy, Menlo Park, CA (US); Greg Tatem, Moraga, CA (US); Howard Field, Menlo Park, CA (US)

Correspondence Address: DLA PIPER LLP (US ), 2000 UNIVERSITY AVENUE, EAST PALO ALTO, CA, 94303-2248, US

(73) Assignee: Picaboo Corporation, Menlo Park, CA (US)

(21) Appl. No.: 12/237,252

(22) Filed: Sep. 24, 2008

Related U.S. Application Data
(60) Provisional application No. 60/975,408, filed on Sep. 26, 2007.

(51) Int. Cl. G06F 3/048

(52) U.S. Cl. 715/764

(57) ABSTRACT

A greeting card system and method are provided that allows a user to place images on each side of a greeting card.

### PRIORITY CLAIM

This application claims priority from and the benefit under 35 USC 119(e) to U.S. Provisional Patent Application Ser. No. 60/975,408 filed on Sep. 26, 2007 and entitled “Greeting Card System and Method”, the entirety of which is incorporated herein by reference.

### FIELD

A system and method for laying out, assembling and generating a greeting card.

### BACKGROUND

Systems and method that permit a user to organize a plurality of pieces of content are known. For example, the Picture Manager utility in Windows® allows a user to view a plurality of digital images, arrange the digital images and then view the plurality of digital images as a slide show. There are also systems that allow a user to create electronic greeting cards in which the user can insert a greeting. However, no existing system is capable of allowing the user to place their own images, layouts and backgrounds on each surface of the greeting card and it is to this end that the system and method are directed.

### BRIEF DESCRIPTION OF THE DRAWINGS

FIG. 1 illustrates an example of a web-based system that includes a greeting card system;

FIG. 2 illustrates an example of the data structures associated with the greeting card system; and

FIGS. 3-6 illustrates examples of the user interface of the greeting card system.

### DETAILED DESCRIPTION OF ONE OR MORE EMBODIMENTS

The system and method are particularly applicable to a web-based greeting card system that is incorporated into a web-based photo book system and it is in this context that the system and method will be described. It will be appreciated, however, that the system and method have greater utility since the system and method can be implemented in different manners than disclosed below and may be used as an independent system (not part of the web-based photo book system) or as a desktop application that connects to the Internet and a website or with other systems in which it is desirable to be able to preview, assemble and generate a greeting card with user images. In an exemplary embodiment, the greeting card system is part of a web-based photo book system that is accessible on the web at www.picaboo.com. Now, an exemplary implementation of the greeting card system and method are described for illustration purposes.

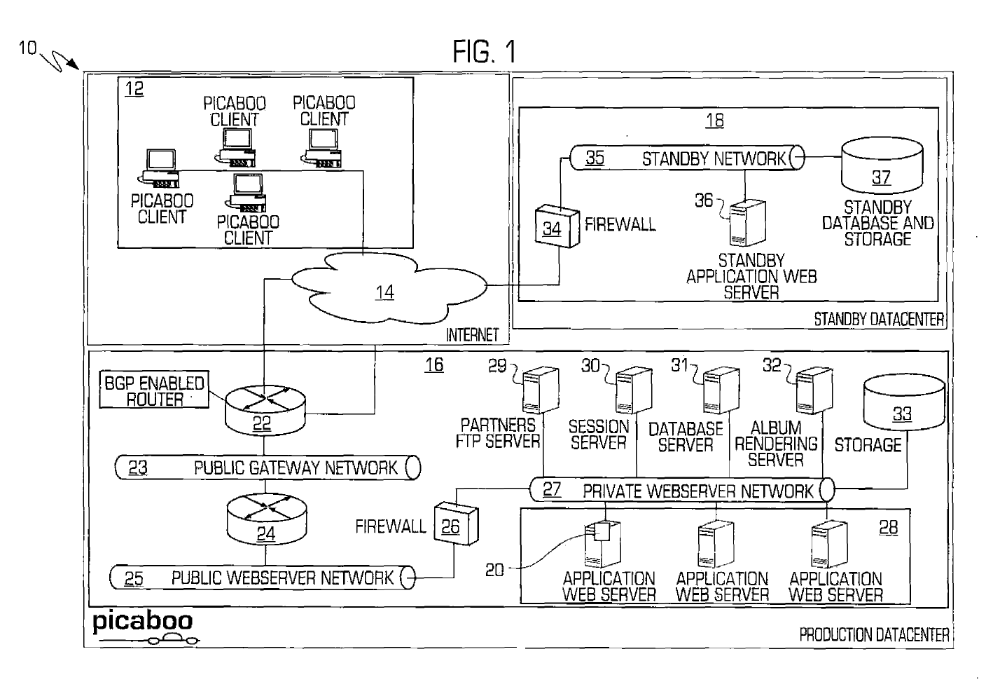

FIG. 1 illustrates an example of a web-based system 10 that includes a greeting card system 20. The web-based system, that may be a photo book system of Picaboo (www.picaboo.com) may include one or more computing devices 102 (such as the plurality of Picaboo clients as shown in FIG. 1) that may each be a processing unit based device with sufficient memory, display capabilities, storage space, processing power and connectivity (wired or wireless) to access and interact with a photo system 16 over a communications link 14 (wired or wireless). For example, each computing device may be a personal computer, laptop computer, desktop computer, a wireless device, a wireless email device, an integrated device such as a RIM Blackberry or Palm Treo device, a mobile phone or a cellular phone. The system 16 may also include a standby portion 18 (also coupled to the communications link 14) that may be used if there is a failure of any portion of the main system. The system 16 may include a typical router device 22, a public gateway network 23 and a second router device 24 that is in turn coupled to a public webserver network 25. The public webserver network 25 is in turn connected to a firewall device 26 that protects the internal network from malicious activities by having all data into and out from the internal systems pass through the firewall. The internal systems (that are behind the firewall) may include a private webserver network 27 and one or more application web servers 28 (one or more of which may execute the greeting card system 20 that may be implemented in software in one embodiment) that receive requests and information from the computing devices and generate one or more web pages that contain information that can be displayed in a known browser application being executed by each computing device. The system may also include a known FTP server 29, a known session server 30, a known database server 31 that receives data requests, queries a storage unit 33 (that stores the various data and information associated with the photo system and the greeting card system 20) and delivers the requested data to the appropriate system element and an album rendering server 33 that renders the bound image albums that are produced by the photo system. The standby system 18 (used in the event of a failure or downtime of the main system) may include a firewall 34, a standby network 35, a standby application web server 36 and a standby database and storage 37. The greeting card system 16 may be used to upload images and then generate a photo album based on the uploaded images of the user.

In one embodiment of the greeting card system, the components of the system shown in FIG. 1 are implemented with the following commercial products:

Firewall
ASA5510

DMZ Layer 2/3
DLink DES-3326SR

Internal Layer 2
Dell PowerConnect 5324

Machine1
Hardware
   IBM 345 (2×Four way Xeon P4 2.8GHZ)
   1.5Gb RAM
   Raid 1 2×34GB
Applications
   Picaboo Administration
   Picaboo Server Configuration
   Picaboo Public Proxy module
   Picaboo Account Verification module
   Picaboo Maintenance Service
   Picaboo Verisign Module
   Picaboo Web Module
   Picaboo File Transfer Module
   Picaboo Preview
   MSQueue Sendmail Service
   Logger
   SRS2 (Renderer)

Machine2
Hardware
   Dell SC1425 (2× Xeon P4 2.8GHZ)
   2Gb RAM
   Raid 1 2×80GB
Applications
   Picaboo Private Proxy module
   MSSQL Server (Standby)
   Picaboo Verisign Module
   Picaboo Web Module
   Picaboo File Transfer Module
   Picaboo Preview
   Logger
   Community

Machine3
Hardware
   Dell SC1825 (2× Xeon P4 3GHZ)
   2Gb RAM
   1×36GB
Applications
   Picaboo Verisign Module
   Picaboo Web Module
   Picaboo File Transfer Module
   Picaboo Preview
   Logger
   Backgrounds
   SRS2 (Renderer)

Machine4
Hardware
   Dell SC1425 (2× Xeon P4 2.8GHZ)
   2Gb RAM
   Raid 1 2×80GB
Applications
   SRS2 (Renderer)
   MSSQL Server

Machine5
Hardware
   Dell Powervault 745N (Xeon P4 2.8GHZ)
   1Gb RAM
   Raid 5 3×600GB
Applications
   Filecache

Machine 2 (shown above) may provide the following resources to internal network servers:

| | |
|---|---|
| albumOrders: | Used to store album order files. |
| dvdOrders: | Used to store dvd order files. |
| Preview: | Used to store thumbnails and preview pages. |
| printOrders: | Used to store print order files. |
| Templates: | Used to store email template and images. |
| Templates2: | Hi res templates used by SRS2. |
| PicabooCache: | Used to store Picaboo album files. |
| Backgrounds: | Used to store backgrounds uploaded. |
| RPIBackup: | Backup of RPI orders |
| Uploads: | Used to store community uploads. |

The main client application (that interacts with Picaboo clients in FIG. 1) is the Picaboo application. The web application is this implementation may include the private proxies, account verification, file transfers, order pages and/or preview. The server application in the implementation may include album publishing, image extraction, data synchronization, rendering, user gateway, user registration and the session server.

The greeting card system may also include data types that are associated with the greeting card system that may include a theme data type, a background data type, a layout data type, a media wells data type and/or a caption data type.

Themes

Themes are a data structure that contain collections of backgrounds and layouts. Examples of themes include a travel theme where background images include collages of postage stamps, bamboo, etc... The travel theme layouts are angled and fun, with caption boxes for the user to tell the story of their trip.

Backgrounds

Backgrounds are images that are displayed in a z-order behind the layouts.

Layouts

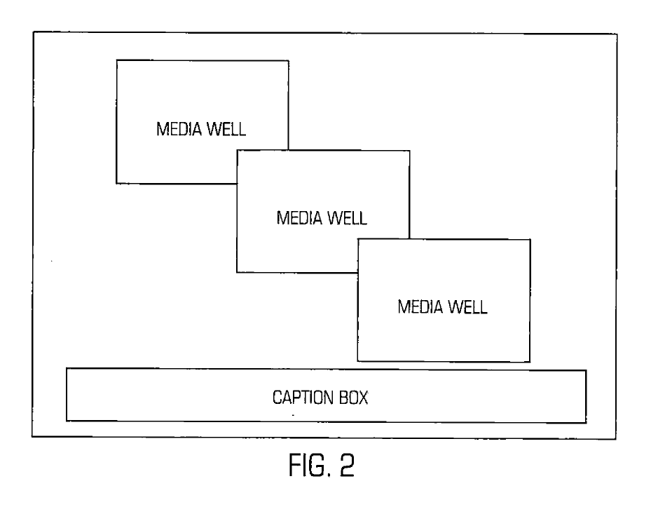

Layouts consist of Media Wells, and Caption Boxes as shown in FIG. 2.

Media Wells

Media Wells are rectangles that position the image on the album page. Media Wells can have optional borders and shadows applied to them. There can be n-number of Media Wells in a layout. Media Wells can be angled or straight, portrait or landscape. Media Wells can be of various sizes.

Caption Boxes

Caption Boxes are rectangles positioned on the layout to provide the user a defined area in which the user can type text. Caption Boxes are of various sizes and number.

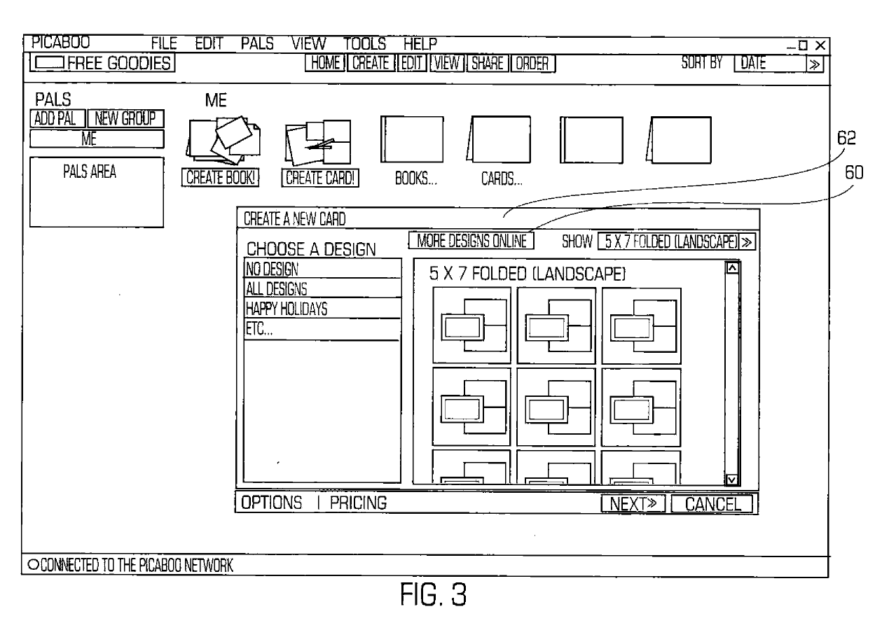

The greeting card system and method provides, in the embodiment when it is integrated with the photo system, an integrated system that allows the user to create a custom greeting card using a plurality of professionally designed backgrounds, layouts, and user provided images that can be applied to all surfaces of the greeting card. FIGS. 3-6 illustrates examples of the user interface of the greeting card system. The greeting card system and method that includes choosing a design process, selecting one or more photos process, editing the greeting card process, selecting a layout process, selecting a background process and dragging photos/images into the layout process is now described in more detail. In one embodiment of the system, the processes described below are carried out by a plurality of lines of computer code being executed by a processing unit based device such as the application server shown in FIG. 1.

Choose a Design

As shown in FIG. 3, the greeting card method may start with choosing a design using a choose a design user interface 60. The user can select from a number custom designs based on Themes as described above or the user can also retrieve more designs by selecting the “More Designs Online” button 62 which will take them to a web site where they can download more designs.

Select Photos

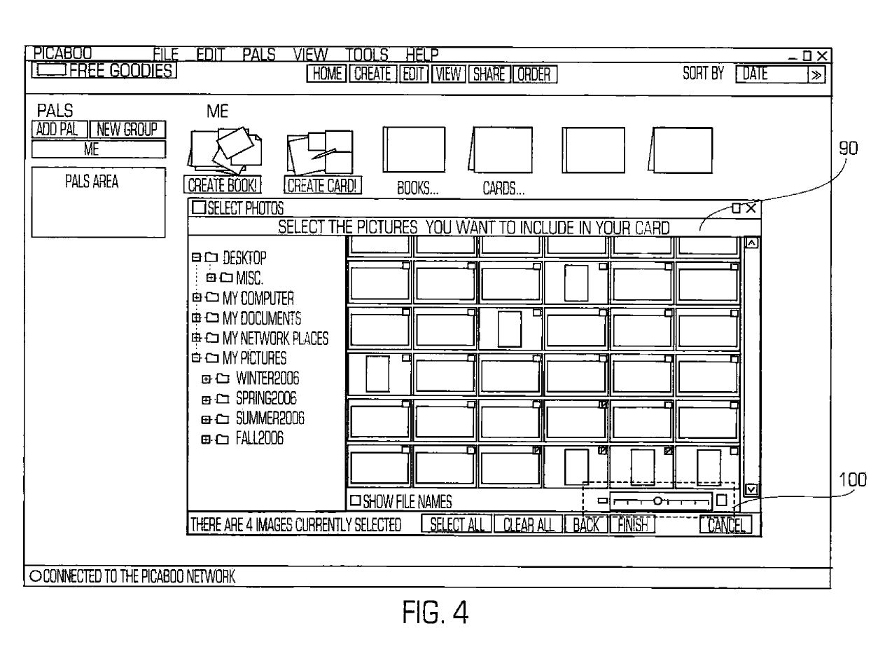

Once the user has selected a design, had a default design selected or selected no design, the greeting card system allow the user to optionally select zero or more images/photos/content to include in/with their greeting card using a select photos user interface 90 as shown in FIG. 4. In this user interface, the size of the thumbnails of each photo/image can be adjusted by using a slider (100).

Edit Card

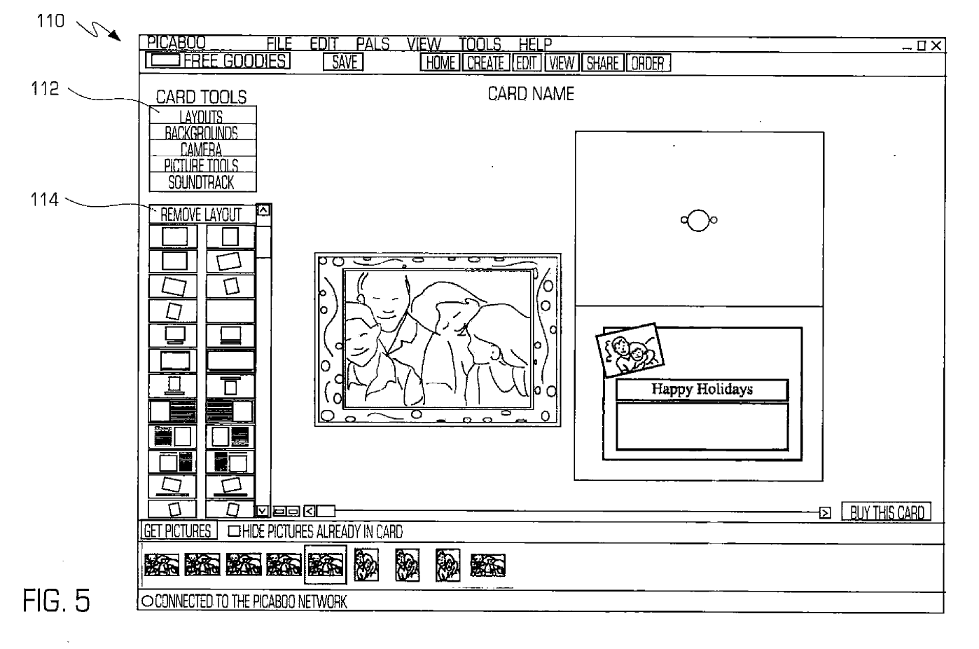

Once the user has selected any photos/images/content for the greeting card, the user can edit the greeting card (once it has been named) using a card editing user interface 110 as shown in FIG. 5. Depending on the card type selected, all editable surfaces for the particular type of greeting card are displayed to the user. The user can then customize each surface of the card by selecting from layouts, backgrounds, adding custom corners to media wells, and entering text into caption boxes from the user interface shown in FIG. 5.

Select Layout

The layouts can selected for any surface of the card by selecting “Layouts” from the context panel (112) and then choosing from the thumbnails images of the various Layouts 114 as shown in FIG. 5.

Select Background

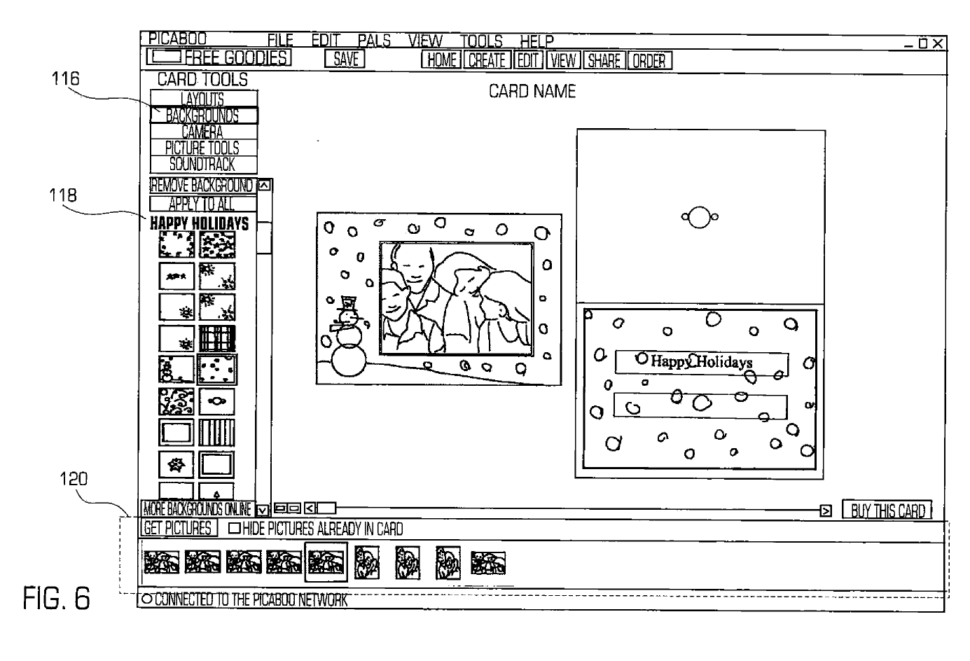

Backgrounds can selected for any surface of the card by selecting “backgrounds” from the context panel (116) and then choosing from the thumbnails images of the various backgrounds 118 as shown in FIG. 6.

Drag Photos into Layout

The greeting card system also allows the user to drag and drop photos/images/content from a media tray 120 into one or more media wells that exist for the particular type of greeting card selected by the user.

While the foregoing has been with reference to a particular embodiment of the invention, it will be appreciated by those skilled in the art that changes in this embodiment may be made without departing from the principles and spirit of the invention, the scope of which is defined by the appended claims.

1. A content system, comprising:
a content unit;
a greeting card unit that is part of the content unit;
the greeting card unit that allows a user to create a greeting card having one or more surfaces for content and place a piece of content on each surface of the greeting card wherein the piece of content further comprises a background and an image.

2. The system of claim 1, wherein the one or more surface for content further comprises one or more media wells into which content may be placed.

3. The system of claim 1 further comprises one or more computing devices that access the content system over a link and wherein the content system further comprises one or more server computers and the story flow unit further comprises a plurality of lines of computer code executed by the one or more server computers.

4. The system of claim 3, wherein each computing device further comprises a personal computer, a laptop computer, a desktop computer, a wireless device, a wireless email device, an integrated device, a mobile phone or a cellular phone.

5. The system of claim 1, wherein the content unit further comprises a caption box that permits a user to place text into the caption box wherein the text will be printed on the greeting card.

6. The system of claim 1, wherein the piece of content further comprises a photo.

7. A computer implemented greeting card generation method having a content unit and a greeting card unit that is part of the content unit, the method comprising:
providing a greeting card having one or more surfaces;
selecting a background for the greeting card; and
selecting at least one piece of content to be inserted into at least one of the surfaces.

8. The method of claim 7 further comprising choosing, by a user, a design for the greeting card.

9. The method of claim 7, wherein the piece of content further comprises a photo.
